(19) United States
(12) Patent Application Publication
(10) Pub. No.: US 2007/0126597 A1
(43) Pub. Date: Jun. 7, 2007

(54) Remote control identification means

(76) Inventors: Nichola C. McMurtry, La Conner, WA (US); Herbert McMurtry, La Conner, WA (US)

Correspondence Address: JAMES RAY & ASSOCIATES, 2640 PITCAIRN ROAD, MONROEVILLE, PA, 15146, US

(21) Appl. No.: 11/294,259

(22) Filed: Dec. 5, 2005

(51) Int. Cl. G08C 19/16

(52) U.S. Cl. 340/870.01

(57) ABSTRACT

A remote control identification system includes a first housing member. At least one wireless signal receiving unit is disposed at least one of in and on the first housing member. An at least one of a visual and an audio device is disposed in or on the housing member in communication with the signal receiving unit for alerting an owner of such objects of their presence upon receipt of a signal by the signal receiving unit. A first power source is connected to each of the wireless receiving unit and the at least one of a visual and an audio device for supplying power thereto. A second housing member is also provided. There is at least one wireless signal transmitter for supplying such signal to the signal receiving unit disposed one of in or on the second housing member. A second power source is connected to such wireless signal transmitter for supplying power thereto.

### FIELD OF THE INVENTION

The present invention relates, in general, to personal property identification systems and, more particularly, this invention relates to a remotely controlled identification means.

### BACKGROUND OF THE INVENTION

There has always been a problem with being able to identify articles, such as luggage, backpacks, laptop computer cases and similar items that belong to an individual. This problem is compounded by the number of travelers in today's society. This is particularly true in travel situations such as the baggage claim area at most airports. It is difficult to quickly identify these items and retrieve the correct bag when faced with hundreds of similar items at a baggage carousel. Locking of luggage or laptop computers or other such items, at least prevents others from obtaining possible vital information from them.

Since many bags or luggage items look so similar even from different manufacturers finding these items when they are passing quickly before you is sometimes very difficult. However, bags or other items which have distinctive labeling or with distinctive tracking systems attached thereto are easy to locate and, thus, makes retrieval of these items easy.

It would be advantageous for travelers today if their bags or other such items could be equipt with such distinctive tracking systems easily and inexpensively and thereby reduce the anxiety of finding the proper checked baggage at an airport or other travel means.

### SUMMARY OF THE INVENTION

The present invention provides an improved remote control identification system for enabling positive identification of various preselected personal objects. Such remote control identification system includes a first housing member having a first predetermined size and a first predetermined shape. A at least one wireless signal receiving unit is disposed at least one of in and on such first housing member. There is at least one of a visual and an audio means disposed at least one of in and on the housing member in communication with the signal receiving unit for alerting an owner of such preselected objects of their presence upon receipt of a signal by such signal receiving unit. A first power source is connected to each of the at least one wireless receiving unit and such at least one of a visual and an audio means for supplying power thereto. A second housing member having a second predetermined size and a second predetermined shape is provided. Disposed at least one of in and on such second housing member is at least one wireless signal transmitting means for supplying such signal to be sent to the signal receiving unit and a second power source is connected to such at least one wireless signal transmitting means for supplying power thereto.

### OBJECTS OF THE INVENTION

It is, therefore, one of the primary objects of the present invention to provide a system for tracking baggage items such as luggage, laptop computers and other items.

Another object of the present invention is to provide a tracking system which includes a locking means to secure the baggage.

Yet, another object of the present invention is to provide a tracking system which will identify such baggage items by using existing and future technology such as radio frequency identification.

Still another object of the present invention is to provide a tracking system which uses a receiving device either on or in such baggage which emits lights or musical sounds when activated.

It is another object of the present invention to provide a tracking system which uses a remote device to activate the receiving device disposed in the baggage.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a block diagram of the remote control identification system according to the present invention.

FIG. 2 is a top view of a remote control bag identifier having a transmitting means disposed therein according to one embodiment of the invention.

FIG. 3 is a partial perspective view of the remote control bag identifier shown in FIG. 2 attached to a standard set of car keys.

FIG. 4 is a partial perspective view of one embodiment of the invention showing a housing member having a receiving means and a visual means disposed therein.

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

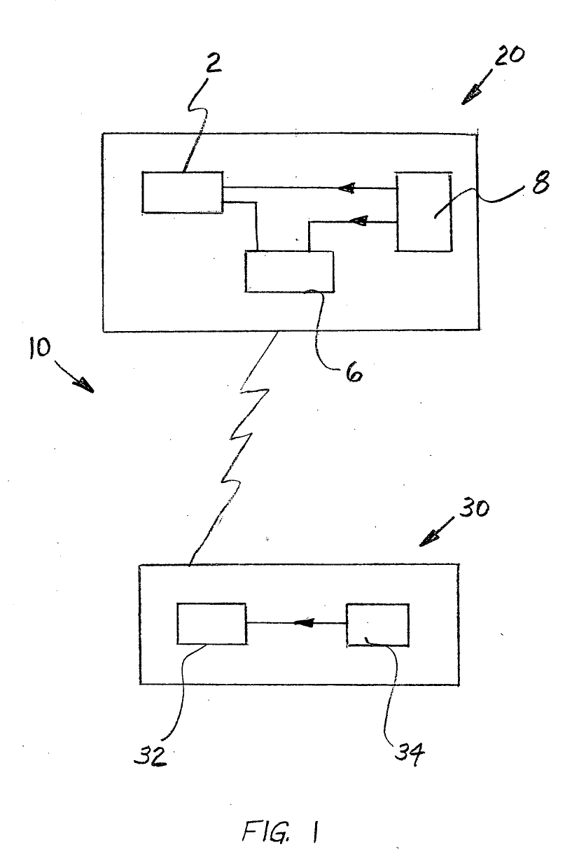

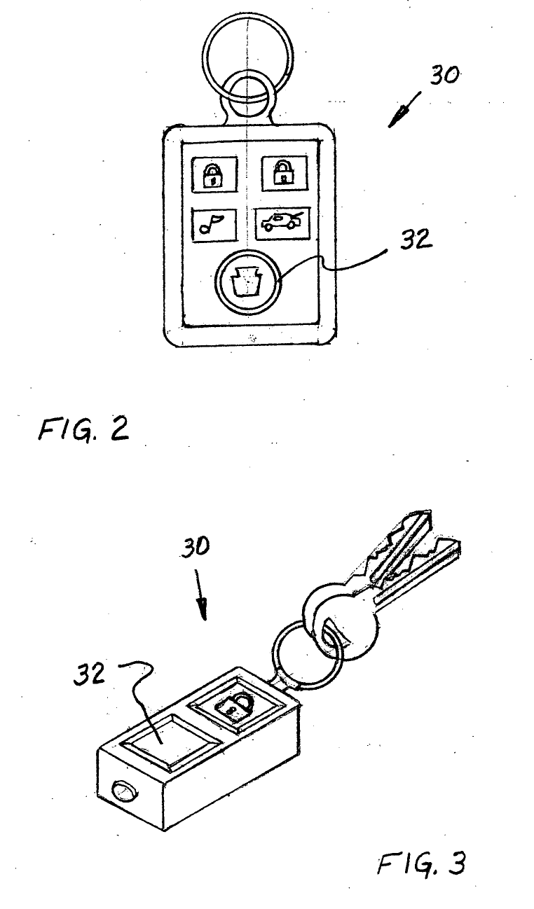

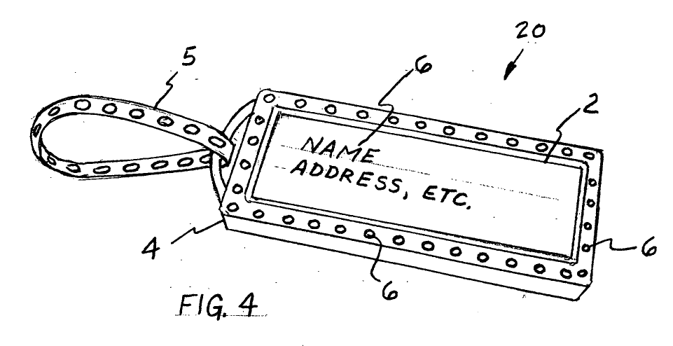

Reference is now made to FIGS. 1-4, illustrated therein is an embodiment of the invention. The present invention provides an improved remote control identification system, generally designated 10, for enabling positive identification of various preselected personal objects. Such remote control identification system 10 includes a first housing member, generally designated 20, having a first predetermined size and a first predetermined shape. The first housing member 20 has at least one wireless signal receiving unit 2 disposed at least one of in and on such first housing member 20. In one embodiment of he invention, as seen in FIGS. 1 and 2, such housing member 20 is a luggage tag 4. There is at least one of a visual and an audio means 6 disposed at least one of in and on the housing member 20 in communication with the signal receiving unit 2 for alerting an owner of such preselected objects of their presence upon receipt of a signal by such signal receiving unit 2. There is also a first power source 8 connected to each of the at least one wireless receiving unit 2 and such at least one of a visual and an audio means 6 for supplying power thereto. FIG. 4 show a visual means 6 such as flashing lights around the perimeter of the tag 4 and the tag holder 5 and also shows a name on the tag 4 that also light up while the tag holder 5 also may have lights 6 on it. Such means 6 could also be an audio means wherein such tag 4 could emit a distinctive musical sound, melody, beep or a saying that would be easily recognizable to the owner of the luggage.

It is within the scope of the invention that such first housing member 20 could be disposed within such luggage itself, rather than just on the name tag 4 attached to the luggage. Further, it is within the scope that such luggage could be lit at preselected locations if it were equipt with such visual means 6. Such luggage could emit a distinctive audio message 6 such as a musical sound, a melody or a distinctive beep if equipt with an audio means 6 or the first housing member 20 could be set up so that it would emit both a visual signal 6 and an audio signal 6.

There is also a second housing member, generally designated 30, having a second predetermined size and a second predetermined shape provided. Disposed at least one of in and on such second housing member 30 is at least one wireless signal transmitting means 32 for supplying such signal to be sent to the signal receiving unit 2 and a second power source 34 is connected to such at least one wireless signal transmitting means 32 for supplying power thereto.

As seen in FIGS. 2 and 3 one embodiment of the invention provides that such wireless signal transmitting means 32 is in a housing 30 which is a remote unit 34 similar to an automobile remote keyless entry with a set of car keys attached. The remote unit 34 of housing 30 has a button for sending a signal to such wireless receiving unit 2 disposed in or on such housing 20 to activate the lights 6 on the tag 4 seen in FIG. 1 or 2. Such unit 34 also has a button which would send a signal to activate the audio identification means 6 if such were employed. As seen in the drawing Figures such housing 30 for such remote unit 34 could be a unit such as the remote keyless entry which also holds the car keys wherein a button disposed on this second housing member will activate the signal transmitting means 32 for supplying the signal to be sent to the signal receiving unit 2.

Illustrated in FIG. 1 is a partial block diagram displaying the important features of the invention of the remote control identification means.

It is presently preferred that such first power source 8 and such second power source 34 are batteries. Such batteries could be any variety of batteries such AA, AAA or even hearing aid batteries or watch batteries. For convenience, it is preferred that such batteries are AA batteries.

Such audio means 6 includes a recording device for recording a personal message. Such personal message could be “This luggage belongs to Nikki” or some similar expression so that when activated the message will be quite distinctive.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

We claim:

1. A remote control identification system for positive identification of various preselected personal objects, said remote control identification system comprising:
(a) a first housing member having a first predetermined size and a first predetermined shape;
(b) at least one wireless signal receiving unit disposed at least one of in and on said first housing member;
(c) at least one of a visual and an audio means disposed at least one of in and on said housing member in communication with said signal receiving unit for alerting an owner of such preselected objects of their presence upon receipt of a signal by said signal receiving unit;
(d) a first power source connected to each of said at least one wireless receiving unit and said at least one of a visual and an audio means for supplying power thereto;
(e) a second housing member having a second predetermined size and a second predetermined shape;
(f) at least one wireless signal transmitting means for supplying said signal to be sent to said signal receiving unit disposed at least one of in and on said second housing member; and
(g) a second power source connected to said at least one wireless signal transmitting means for supplying power thereto.

2. The remote control identification system, according to claim 1, wherein said first power source is at least one battery.

3. The remote control identification system, according to claim 2, wherein said at least one battery is a AA battery.

4. The remote control identification system, according to claim 1, wherein said second power source is at least one battery.

5. The remote control identification system, according to claim 4, wherein said at least one battery is a AA battery.

6. The remote control identification system, according to claim 1, wherein said visual means includes lights.

7. The remote control identification system, according to claim 1, wherein said first housing member is a luggage tag.

8. The remote control identification system, according to claim 7, wherein said luggage tag has a name imprinted thereon which lights up when activated.

9. The remote control identification system, according to claim 7, wherein said luggage tag has a pattern of flashing lights around a perimeter of said luggage tag.

10. The remote control identification system, according to claim 1, wherein said audio means includes a recording device for recording a personal message.

11. The remote control identification system, according to claim 1, wherein said audio means includes at least one of a distinctive musical sound, a melody and a distinctive beep.

12. The remote control identification system, according to claim 11, wherein said audio means has a distinctive beep.

13. The remote control identification system, according to claim 1, wherein said first housing member with said at least one a visual and an audio means disposed therein is disposed at least one of within and on luggage.

14. The remote control identification system, according to claim 1, wherein said second housing member is incorporated into an automobile remote keyless entry system.

15. The remote control identification system, according to claim 1, wherein said second housing member is a stand alone remote control device similar to an automobile remote keyless entry system.

16. The remote control identification system, according to claim 15, wherein a button disposed on said second housing member will activate said signal transmitting means for supplying said signal to be sent to said signal receiving unit.

17. The remote control identification system, according to claim 1, wherein said remote control identification system includes both an audio and a visual identification means.
